(19) United States
(12) Patent Application Publication
(10) Pub. No.: US 2017/0355383 A1
(43) Pub. Date: Dec. 14, 2017

(54) OPERATING UNIT FOR A MOTOR VEHICLE AND METHOD FOR OPERATING AN OPERATING UNIT OF A MOTOR VEHICLE

(71) Applicant: Dr. Ing. h.c. F. Porsche Aktiengesellschaft, Stuttgart (DE)

(72) Inventor: Martin Klos, Schoenaich (DE)

(21) Appl. No.: 15/619,579

(22) Filed: Jun. 12, 2017

(30) Foreign Application Priority Data
Jun. 14, 2016 (DE) 10 2016 110 850.2

(51) Int. Cl. B60W 50/08; G08G 1/00; B60W 40/08; B60R 16/037; G08G 1/127

(52) U.S. Cl. CPC B60W 50/08; B60R 16/0373; G08G 1/127; B60W 40/08; G08G 1/205; G08G 1/20

(57) ABSTRACT

An operating unit for a motor vehicle includes a vehicle interface that forms an interface between the motor vehicle and a driver, a central control unit configured to control a vehicle state and/or an operating element of the vehicle interface, and a data interface that is connected to the central control unit and that forms a wireless link between the central control unit and an external data service. The data interface is configured to transmit data from the vehicle interface to the external data service. The data interface is configured to transmit data from the external data service to the vehicle interface via the central control unit.

### CROSS REFERENCE TO RELATED APPLICATIONS

This application claims benefit to German Patent Application No. DE 10 2016 110 850.2, filed Jun. 14, 2016, which is hereby incorporated by reference herein.

### FIELD

The present invention relates to an operating unit for a motor vehicle having a vehicle interface that forms an interface between the vehicle and the driver, a central control unit that is configured to control a vehicle state and/or an operating element of the vehicle interface, a data interface that is connected to the central control unit and forms a wireless link between the central control unit and an external data service, wherein the data interface is configured to transmit data from the vehicle interface to the external data service. The present invention furthermore relates to an operating system for a motor vehicle having an external data service for providing operating instructions for a vehicle interface. The present invention finally relates to a method for operating an operating unit of a motor vehicle having the steps of querying a function of an operating unit via a vehicle interface that forms an interface between the motor vehicle and the driver, wherein the vehicle interface is configured with a central control unit for controlling a vehicle state and/or an operating element of the vehicle interface, and transmitting data from the vehicle interface to an external data service via a data interface that forms a wireless link between the central control unit and the external data service.

### BACKGROUND

Operating units in motor vehicles serve for assistance when operating vehicle functions such as for example functions of the infotainment system. Owing to the multiplicity of and the constantly increasing number of functions in motor vehicles, operating the comprehensive systems in motor vehicles becomes increasingly complex, with the result that the driver does not use or only partially uses the vehicle systems, or complicated explanations from the dealer are necessary to explain the vehicle systems to the driver.

### SUMMARY

In an embodiment, the present invention provides an operating unit for a motor vehicle. The operating unit includes a vehicle interface that forms an interface between the motor vehicle and a driver, a central control unit configured to control a vehicle state and/or an operating element of the vehicle interface, and a data interface that is connected to the central control unit and that forms a wireless link between the central control unit and an external data service. The data interface is configured to transmit data from the vehicle interface to the external data service. The data interface is configured to transmit data from the external data service to the vehicle interface via the central control unit.

### BRIEF DESCRIPTION OF THE DRAWINGS

The present invention will be described in even greater detail below based on the exemplary figures. The invention is not limited to the exemplary embodiments. All features described and/or illustrated herein can be used alone or combined in different combinations in embodiments of the invention. The features and advantages of various embodiments of the present invention will become apparent by reading the following detailed description with reference to the attached drawings which illustrate the following:

FIG. 1 shows a schematic illustration of an operating unit for a motor vehicle that is connected to an external data service;

FIG. 2 shows a detailed illustration of an operating unit of a motor vehicle; and

FIG. 3 shows a detailed view of an operating system having an operating unit that is connected to an external data service.

### DETAILED DESCRIPTION

An operating unit of a motor vehicle and a method for operating an operating unit of a motor vehicle are described herein that explain the use of functions and operating features and thus facilitate operation of complex driver/vehicle interfaces.

An operating unit is described herein having a data interface being configured to transmit data from an external data service to a vehicle interface via a central control unit. A method is described herein in which data is transmitted from an external data service to a vehicle interface via a central control unit. An operating system is described herein having an operating unit including a data interface configured to transmit data from an external data service to a vehicle interface via a central control unit.

Since the data interface both transmits data from the vehicle interface to the external data service and can transmit data from the external data service to the vehicle interface via the central control unit, an external control of the vehicle interface can be displayed as instructions for operating the vehicle interface, and operation of the vehicle interface can thus be facilitated for the driver.

In a preferred embodiment, the vehicle interface has a voice interface for transmitting voice messages. As a result, it is possible to guide a driver through a menu simply by way of voice messages.

In a further embodiment, the data interface and the central control unit are configured to transmit the voice messages to the vehicle interface. As a result, a driver as a user of the vehicle interface can be guided through the menu safely even while he is driving.

In a further embodiment, the vehicle interface has at least one manual operating element. As a result, the operation of the vehicle interface can generally be operated like a button, switch, rotary reset actuator or the like, wherein in a particular embodiment, the manual operating element can be configured such that it is illuminated.

In a further embodiment, the data interface and the central control unit are configured to transmit optical messages to the at least one manual operating element. As a result, it is possible to explain to the driver, with little outlay, individual operating steps of the manual operating elements, for example by way of illuminated operating elements.

In a particular embodiment, the vehicle interface has a screen and in particular a screen having touch input function, such as for example a touchscreen. As a result, it is possible to explain to the driver simple visualized steps for operating the vehicle interface, for example by displaying arrow borders or flowcharts or explanatory videos.

In a preferred embodiment, the data interface and the central control unit are configured to transmit optical messages to the vehicle interface. As a result, menu guidance can be represented to the driver with technically little outlay.

In a preferred embodiment, the data interface is configured to transmit data to the central control unit and to control the vehicle interface on the basis of the transmitted data. As a result, the external data service can generally assume control of the vehicle interface and perform settings, such that in general settings of the operating unit can be undertaken for the driver.

In a further embodiment, the data interface is configured to transmit updated function data to the central control unit for controlling a vehicle state and/or an operating element. As a result, current vehicle configurations or updates of the software can be transmitted from the external data service to the central control unit of the motor vehicle.

In a preferred embodiment, the external data service is configured as a voice-guided computer system. As a result, the transmission of the data can be provided cost-effectively with little outlay.

In a further embodiment, the external data service is configured in the form of a call center. As a result, competent and user-friendly instructions can be provided to the driver.

In a further embodiment, the data interface is configured to transmit the data from the external data service to the central control unit in encrypted form. As a result, secure control of the operating unit by the external data service is possible.

Overall, it is possible with the operating unit and the method for operating the operating unit to provide a simple system that explains to a driver the constantly increasing number of functions and setting features of operating units, such as for example infotainment systems and navigation systems, and, if necessary, performs settings, such that the functions of the motor vehicle can be used accordingly.

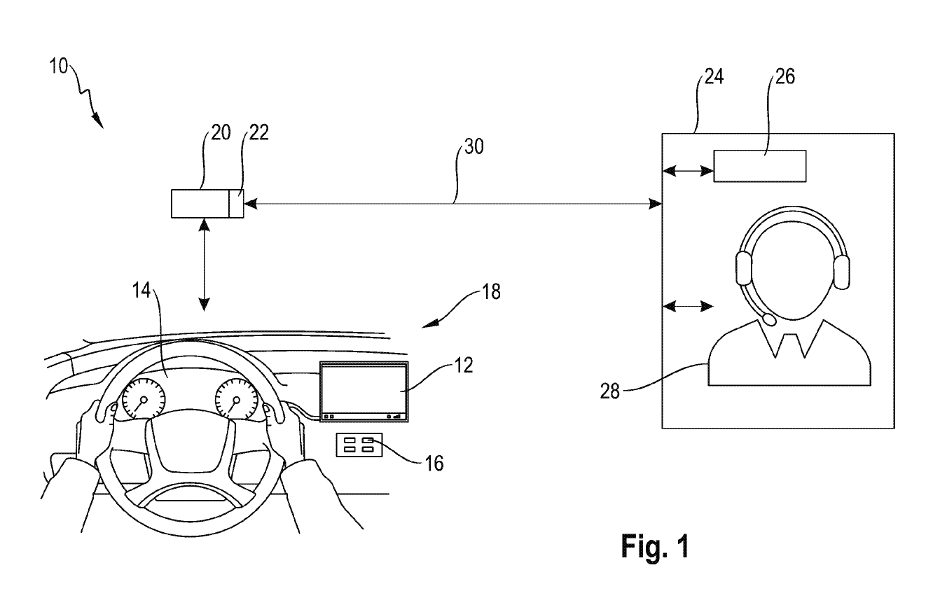

FIG. 1 illustrates a schematic view of an operating unit for a motor vehicle, generally designated with 10. The operating unit 10 is generally made up of an infotainment system 12, a cluster instrument 14 and further buttons or switches 16 or touchscreens that generally form a user interface 18 between the driver and the vehicle. Owing to the multiplicity of setting features and linking features in modern motor vehicles that relate both to the vehicle setting and to the infotainment, navigation or communication setting, it is difficult even for technically versed users or drivers to operate or set all functions and setting features and accordingly to completely use the features of the motor vehicle.

The operating unit 10 generally has a central control unit 20 that controls the user interfaces 18 and is connectable to an external data service 24 via a data interface 22. The central control unit 20 can include a processor and a memory having stored thereon processor executable instructions. The data interface 22 can be a transceiver. The external data service 24 is here a stationary data service that may be configured as a computer system 26, such as for example in the form of a voice-guided computer system 26 or as a call center 28. The data interface 22 is here connected or connectable to the external data service 24 via a wireless radio link 30. The radio link 30 forms an encrypted data link that can be connected to the central control unit 20 and the motor vehicle in general via the data interface 22, and can accordingly make visible to the user operating steps and settings of the user interfaces 18 and perform them in a comprehensible manner.

If the user needs help with respect to settings of the user interfaces 18 or the vehicle in general, or settings of the vehicle and/or of the user interfaces 18 need to be performed, this can be by the external data service 24 done via the radio link 30, and corresponding help can be offered to the user.

The current state of the motor vehicle and in particular the state of the operating elements 16, of the infotainment 12, of the cluster instrument 14, the current vehicle configuration is transmitted to the external data service 24 via the central control unit 20 and the data interface 22 and the radio link 30, and corresponding settings and configurations of the motor vehicle and of the user interfaces 18 can be performed. Furthermore, it is also possible for software updates or the like to be transmitted to the central control unit 20 and the operating unit 10 in general via the radio link 30, such that, when the external data service 24 is used, always the most recent function of the software can be used.

If the user utilizes the help function via the external data service 24, the instruction or the operating steps can be performed, among others, by voice output, by video display for example of the infotainment system 12 by way of arrows, borders by displaying explanatory videos or by illuminated vehicle operating elements 16, such as for example buttons, switches or rotary reset actuators, and in the process in particular by switching on and off illumination and color change of illumination means.

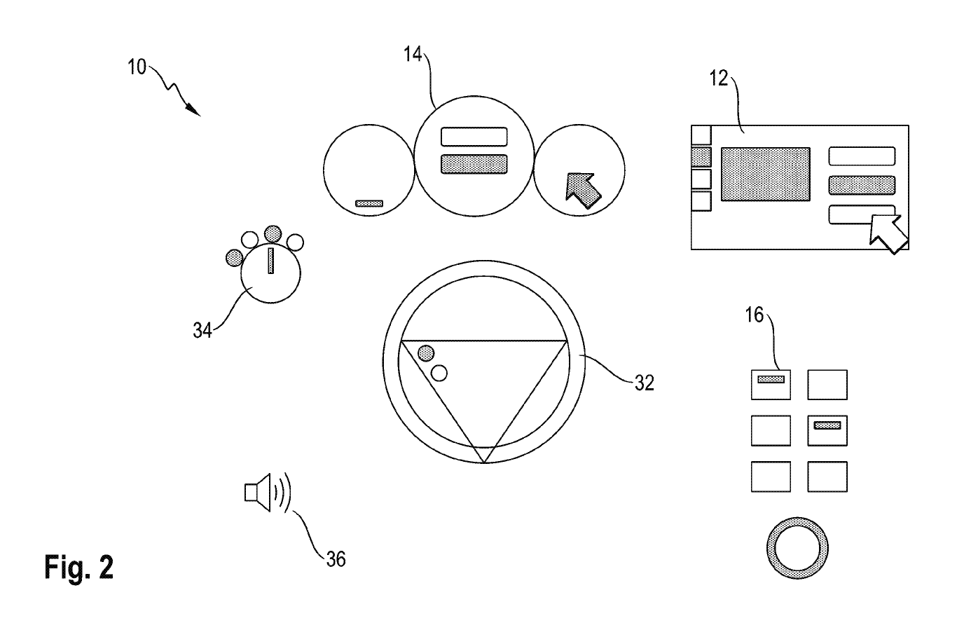

FIG. 2 illustrates a detailed view of the operating unit 10 for explaining the operating steps. The operating unit 10 here includes the infotainment 12, the cluster instrument 14, the buttons 16 and a steering wheel 32, a rotary switch 34 and an audio output and input 36.

In the corresponding menu guidance by way of the external data service 24, buttons or switches on the steering wheel 32, rotary positions of the rotary switch 34, individual switches 16 can be illuminated for example by color change or flashing in order to explain a menu guidance. Furthermore, positions and menu guidance in the cluster instrument 14 and in the infotainment system 12 can be represented by way of arrows, borders or the like, so as to explain a menu guidance by way of the external data service 24. Using audio input and output 36, menu guidance can also be explained verbally, and, if the external data service 24 is formed by a call center 28, the driver can accordingly ask questions to achieve easier menu guidance.

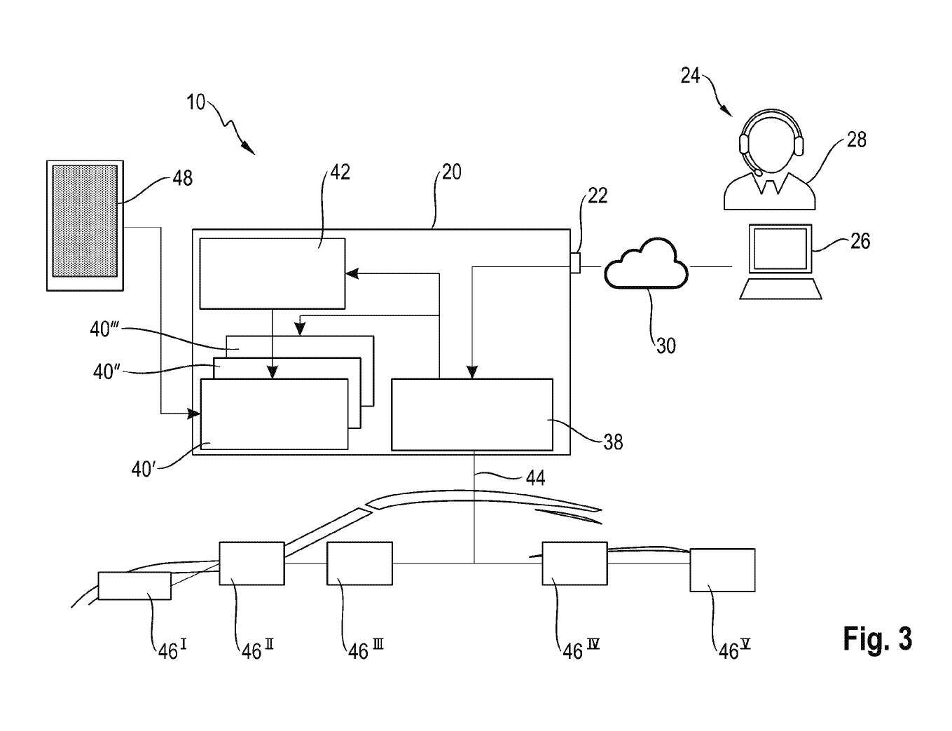

FIG. 3 illustrates a detailed view of the operating unit 10 and in particular of the central control unit 20. The central control unit 20 is connected to the external data service 24 via the data interface 22 and the radio link 30 and has a server 38 as a remote service that is connected to various web servers 40′, 40″, 40′″ and a HMI interface as a client 42. The remote service or the server 38 is connected to various control devices 46 of the motor vehicle via a vehicle bus 44 so as to correspondingly control these control devices 46 via the external data service 24.

The web servers 40′, 40″, 40′″ can be connected to external devices, such as for example smartphones 48 or the like.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

What is claimed is:

1. An operating unit for a motor vehicle, the operating unit comprising:
a vehicle interface that forms an interface between the motor vehicle and a driver, a central control unit configured to control a vehicle state and/or an operating element of the vehicle interface, and
a data interface that is connected to the central control unit and that forms a wireless link between the central control unit and an external data service,
wherein the data interface is configured to transmit data from the vehicle interface to the external data service, and
wherein the data interface is configured to transmit data from the external data service to the vehicle interface via the central control unit.

2. The operating unit as claimed in claim 1, wherein the vehicle interface has a voice interface for transmitting voice messages.

3. The operating unit as claimed in claim 2, wherein the data interface and the central control unit are configured to transmit voice messages to the vehicle interface.

4. The operating unit as claimed in claim 1, wherein the vehicle interface has at least one manual operating element.

5. The operating unit as claimed in claim 4, wherein the data interface and the central control unit are configured to transmit optical messages to the at least one manual operating element.

6. The operating unit as claimed in claim 1, wherein the vehicle interface has a screen having touch input function.

7. The operating unit as claimed in claim 1, wherein the data interface and the central control unit are configured to transmit optical messages to the vehicle interface.

8. The operating unit as claimed in claim 1, wherein the data interface is configured to transmit data to the central control unit and to control the vehicle interface on the basis of the transmitted data.

9. The operating unit as claimed in claim 1, wherein the data interface is configured to transmit updated function data to the central control unit for controlling the vehicle state and/or the operating element.

10. The operating unit as claimed in claim 1, wherein the external data service is configured as a voice-guided computer system.

11. The operating unit as claimed in claim 1, wherein the external data service is configured in the form of a call center.

12. The operating unit as claimed in claim 1, wherein the data interface is configured to transmit the data from the external data service to the central control unit in encrypted form.

13. An operating system for a motor vehicle, having an external data service for providing operating instructions for a vehicle interface and an operating unit as claimed in claim 1.

14. A method for operating an operating unit of a motor vehicle, the method comprising:
querying a function of an operating unit via a vehicle interface that forms an interface between the motor vehicle and a driver, wherein the vehicle interface is configured with a central control unit for controlling a vehicle state and/or an operating element of the vehicle interface,
transmitting data from the vehicle interface to an external data service via a data interface that forms a wireless link between the central control unit and the external data service, and
transmitting data from the external data service to the vehicle interface via the central control unit.
